(19) United States
(12) Patent Application Publication
(10) Pub. No.: US 2019/0305501 A1
(43) Pub. Date: Oct. 3, 2019

(54) LASER PULSE FILTER AND LASER OUTPUT DEVICE HAVING SAME

(71) Applicant: HANDONG GLOBAL UNIVERCITY INDUSTRYACADEMIC COOPERATION FOUNDATION, Pohang-si, Gyeongsangbuk-do (KR)

(72) Inventors: Tae Jun YU, Pohang-si, Gyeongsangbuk-do (KR); Jihoon JEONG, Pohang-si, Gyeongsangbuk-do (KR); Tae Shin KIM, Pohang-si, Gyeongsangbuk-do (KR); Seryeyohan CHO, Tongyeong-si, Gyeongsangnam-do (KR); Seung Jin HWANG, Pohang-si, Gyeongsangbuk-do (KR)

(73) Assignee: HANDONG GLOBAL UNIVERCITY INDUSTRYACADEMIC COOPERATION FOUNDATION, Pohang-si, Gyeongsangbuk-do (KR)

(21) Appl. No.: 16/317,034

(22) PCT Filed: Jul. 11, 2017
(86) PCT No.: PCT/KR2017/007424

§ 371 Date: Jan. 11, 2019

(30) Foreign Application Priority Data
Jul. 11, 2016 (KR) 10-2016-0087331

(51) Int. Cl. H01S 3/00; H01S 3/10

(52) U.S. Cl. CPC H01S 3/0078; H01S 3/1625; H01S 3/10023; H01S 3/0057

(57) ABSTRACT

A laser output device includes: a laser oscillator for oscillating a source laser pulse; a pulse extender for temporally extending the source laser pulse oscillated by the laser oscillator; an amplifier for amplifying the laser pulse temporally extended by the pulse extender; the laser pulse filter for filtering a pre-pulse and a post-pulse contained in the amplified laser pulse; and a pulse compressor for temporally compressing the laser pulse which has passed through the laser pulse filter.

### TECHNICAL FIELD

The present invention relates to a laser pulse filter and a laser output device having the same, and more specifically to a laser pulse filter capable of filtering a pre-pulse and a post-pulse caused by distortion and a laser output device having the same.

### BACKGROUND ART

A laser output device is used in not only an industrial field but also various scientific research fields. In the device, a ultrashort (fs) laser pulse of ultra-high power (PW) is used for an X-ray source for a scientific research, a nuclear fusion, a particle physics research, a science research for analyzing ultra-extreme physical phenomenon, and the like.

As an output of the ultra-high power laser is increased, a physical environment of an extreme condition can be provided, and thus, research for increasing the output is continuing.

On the other hand, a chirped pulse amplification (CPA) method has been developed for a high output of laser recently.

If the laser pulse is directly amplified, a chirped pulse which can deform the laser pulse at length due to limitations of optical components configuring a laser system.

The chirped pulse amplification method temporally increases the laser pulse which becomes a source with a sufficiently long pulse width so as to be less than a threshold output while laser is amplified and is a technique which compresses a laser pulse to an original ultrashort pulse to generate a high output laser beam when a laser beam is sufficiently amplified to reach the threshold output.

However, even in the CPA method, when the laser beam is amplified, distortion occurs due to heat accumulated in an amplification medium while passing through the amplification medium. Generally, there is a problem that such a distorted pulse is approximately 10⁻⁵ of a main pulse, while the laser output is developed to a high output PW level, a pre-pulse or post-pulse generated by the distortion is also generated in a GW level, and an object is first reacted by a pre-pulse before being reacted by a main pulse, and thereby, it is difficult to obtain a desired result.

Meanwhile, a plasma mirror is used to solve the problem caused by such a distorted pulse, but the plasma mirror is a disposable component which cannot be repeatedly used, and a mechanical alignment device for alignment after the plasma mirror is replaced is necessary. Accordingly, there is a problem that it is inconvenient to use repetitively and it takes a long time.

### DISCLOSURE

### Technical Problem

The present invention is to solve the problem, and an object of the present invention is to provide a laser pulse filter for filtering a pre-pulse and a post-pulse which is generated by using a CPA method and a laser output device having the same.

Objects of the present invention are not limited to the above-described objects, and other objects not described can be clearly understood by those skilled in the art from the following description.

### Technical Solution

In order to solve the above-described problems, according to an aspect of the present invention, a laser output device having a laser pulse filter including a laser oscillator (Laser Oscillator) that oscillates a source laser pulse, a pulse expander (Optical Expander) that temporally stretches the source laser pulse which is oscillated by the laser oscillator, an amplifier (Laser Amplifier) that amplifies the laser pulse which is temporally stretched by the pulse expander, a laser pulse filter (Spatial Filter) that filters a pre-pulse and a post-pulse which are included in the amplified laser pulse, and a pulse compressor (Optical Compressor) that temporally compresses the laser pulse passing through the laser pulse filter, is disclosed.

The laser pulse filter can be installed at a point where the amplified laser is focused.

The laser pulse filter can be installed between the amplifier and the compressor.

A beam expander that expands a diameter of a beam of the amplified laser pulse can be included, and the laser pulse filter can be installed in a location where the beam is focused in the beam expander.

The laser pulse filter can have a filtering hole which filters a post-pulse and a pre-pulse of a focused beam and through which a main pulse passes.

The filtering hole can have a shape in which a radius of a central portion is the smallest and the radius increases toward an entrance and an exit of the laser pulse.

The radius of the central portion of the filtering hole can have a length between a radius of the main pulse of the focused beam and radiuses of hollows of central portions of the pre-pulse and the post pulse.

A radius of the main pulse can be a distance from a point where a maximum intensity of the main pulse appears to a point where an intensity reaches 10⁻⁵ of the maximum intensity, in a shape of the focused beam.

Radiuses of hollows of the central portions of the pre-pulse and the post-pulse can be a distance from a point where beam intensities of the central portions of the pre-pulse and the post-pulse are the smallest in a shape of a focused beam to a point where an intensity becomes 10⁻⁵ of a maximum intensity of the pre-pulse and the post-pulse.

The shape of the focused beam can be obtained by an equation of B{circ(r)e^{iϕ(r,θ)}}=2π∫∫circ(r)e^{iϕ(r,θ)}rdrdθ (At this time, circ(r) means a spatial distribution of beam energy, and φ(r,θ) means distortion of a phase)

Meanwhile, according to another aspect of the present invention, there is provided a laser pulse filter, which filters a pre-pulse and a post-pulse among laser pulses of a laser output device which uses a chirped pulse amplification (CPA) method, in which the laser pulse filter has a filtering hole that is formed to filter the pre-pulse and the post-pulse which are included in an amplified laser pulse.

The filtering hole can have a smallest radius of a central portion and a radius which increases toward an entrance and an exit of a beam.

The radius of the central portion of the filtering hole can have a length between a radius of a main pulse of a focused beam and radiuses of hollows of central portions of the pre-pulse and the post pulse.

The radius of the main pulse can be a distance from a point where a maximum intensity of the main pulse appears to a point where an intensity reaches 10⁻⁵ of the maximum intensity, in a shape of the focused beam.

Radiuses of hollows of the central portions of the pre-pulse and the post-pulse can be a distance from a point where beam intensities of the central portions of the pre-pulse and the post-pulse are the smallest in a shape of a focused beam to a point where an intensity becomes 10⁻⁵ of a maximum intensity of the pre-pulse and the post-pulse.

The shape of the focused beam can be obtained by an equation of B{circ(r)e^{iϕ(r,θ)}}=2π∫∫circ(r)e^{iϕ(r,θ)}rdrdθ (At this time, circ(r) means a spatial distribution of beam energy, and φ(r,θ) means distortion of a phase).

### Advantageous Effects

According to a laser pulse filter and a laser output device having the laser pulse filter of the present invention, there is an effect that it is possible to amplify laser more stably with a very high power because a pre-pulse and a post-pulse generated at the time of amplifying a high-power laser can be effectively removed.

In addition, there is an effect that a repetition rate increases and an economic feasibility is excellent because the laser pulse filter can be used semi-permanently.

In addition, there is an effect that efficiency is excellent and very high power is easily achieved because there is no reflection unlike a reflection method which uses a plasma and filtering is performed by using a method of making a main pulse pass through.

Effects of the present invention are not limited to the effects described above, and other effects not described can be clearly understood by those skilled in the art from description of the claims.

### DESCRIPTION OF THE DRAWINGS

The foregoing summary, as well as the detailed description of the preferred embodiments of the present application set forth below, will be better understood when read in conjunction with the appended drawings. Preferred embodiments are illustrated in the drawings for the purpose of exemplifying the invention. It should be understood, however, that this application is not limited to the correct arrangement and means which are illustrated.

FIG. 1 is a conceptual diagram illustrating a configuration of a chirped pulse amplification device;

FIG. 2 is a diagram illustrating a form of laser amplified by using a chirped pulse amplification method;

FIG. 3 is a diagram illustrating an internal shape of an amplifier of FIG. 1;

FIG. 4 is a graph illustrating a time-dependent intensity shape of a laser pulse in a temporally stretched state before being incident on an original amplification medium;

FIG. 5 is a graph illustrating a shape of a laser pulse after passing through the amplification medium once;

FIG. 6 is a graph illustrating the shape of the laser pulse after passing through the amplification medium four times;

FIG. 7 is a graph illustrating a time-dependent cross-sectional shape of the laser pulse;

FIG. 8 is a perspective view illustrating the laser pulse filter of FIG. 3;

FIG. 9 is a cross-sectional view of FIG. 8;

FIG. 10 is a cross-sectional perspective view of FIG. 8;

FIG. 11 is a view illustrating a state in which the laser pulse filter of FIG. 9 is provided in a beam expander;

FIG. 12 is a view illustrating a state in which the laser pulse filter of FIG. 9 is provided in a reflective beam expander; and

FIG. 13 is a view illustrating a cross section of a circular beam in a coordinate system.

### MODE FOR INVENTION

The preferred embodiments of the present invention by which objects of the present invention can be specifically realized will be described with reference to the accompanying drawings. In describing the present embodiments, the same designations and the same reference numerals are used for the same components, and further description thereof will be omitted.

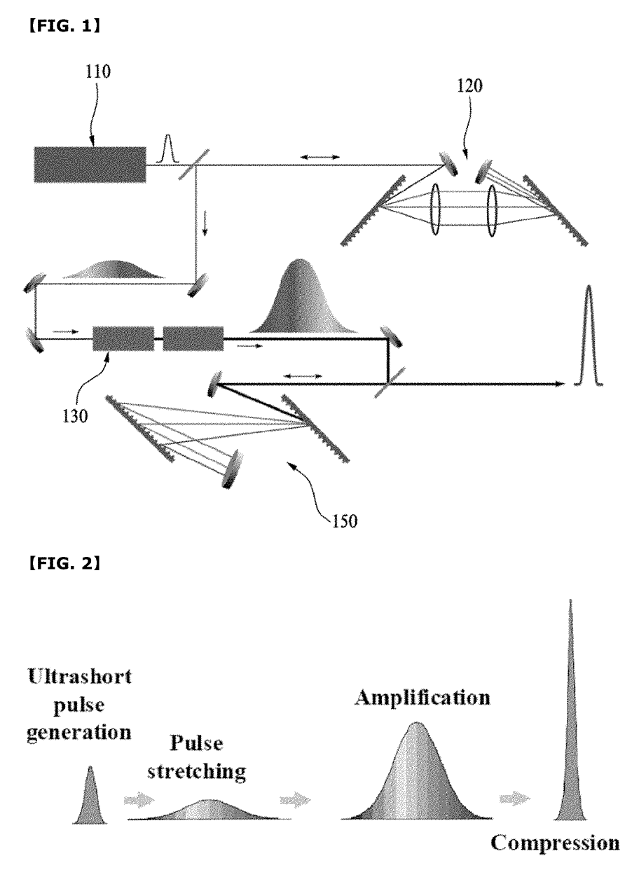

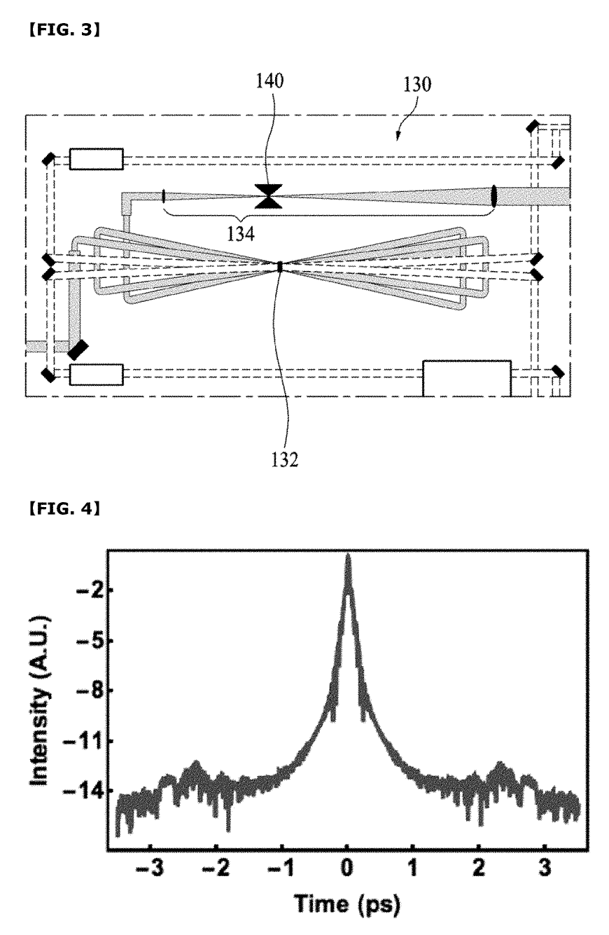

As illustrated in FIGS. 1 and 3, a laser output device having a laser pulse filter according to the present embodiment includes a laser oscillator 110, a pulse expander 120, an amplification device 130, a laser pulse filter 140, and a pulse compressor 150.

As illustrated in FIG. 2, the laser oscillator 110 is a configuration element for oscillating a laser pulse to be a source and oscillates a temporally ultrashort laser pulse.

The pulse expander 120 is a configuration element that stretches greatly and temporally the ultrashort laser pulse generated by the laser oscillator 110.

The amplification device 130 is a configuration element for amplifying the laser pulse temporally stretched by the pulse expander 120. The amplification device 130 includes an amplification medium for amplifying a laser and a sapphire or a YAG can be generally used as the amplification medium. In the present embodiment, a case where Ti:Sapphire is used as the amplification medium will be described as an example.

Ti:Sapphire has a wide amplification wavelength range from 700 nm to 900 nm and can use a beam, which is relatively easy to obtain, having a wavelength of 532 nm as a pump beam for amplification. In addition, Ti:Sapphire has advantages of excellent mechanical and thermal durability.

However, an amplification medium of the amplification device 130 according to the present invention is not limited to Ti:Sapphire, and it is possible to use an amplification medium of another known material therefor.

When the laser pulse is amplified by the amplification device 130, the laser pulse can be amplified to be smaller than a threshold output of the amplification medium.

The laser pulse amplified by the amplifier 130 to be smaller than the threshold output of the amplification medium is compressed to an original ultrashort pulse through the pulse compressor 150 to generate a laser beam having a higher output than the threshold output of the amplification device.

However, heat can be retained by irradiated laser pulse and pump beam, although the laser pulse temporally stretched by the pulse expander 120 is amplified to be smaller than the threshold output of the amplification medium when amplified by the amplification device.

In addition, as illustrated in FIG. 3, in order to stably amplify the laser pulse, the laser pulse passes through an amplification medium 132 in the amplification device 130 several times. At this time, the heat remained in the medium increases, and thereby, the amplification medium 132 expands. Thereby, stress is generated in the amplification medium 132 to distort a shape of a lens and distort a crystal structure, thereby, generating a post pulse and a pre pulse in addition to a main pulse (a full line in FIG. 3 indicates a path of a laser pulse beam which is amplified, and a dotted line indicates a pumping beam).

That is, a part of the beam incident on the Ti:Sapphire amplification medium 132 distorted by the heat is distorted into components of the main pulse and perpendicular components, and the distorted components widens a temporal distance from the main pulse. This is because the Ti:Sapphire amplification medium has a birefringent property and an amplification efficiency differs according to a polarization direction of the beam. The Ti:Sapphire amplification medium exhibits the highest efficiency and the lowest refractive index when the amplification medium is polarized (C-axis polarization direction) in a direction horizontal to a progress direction of the beam. Therefore, the main pulse advances inside the medium at a speed higher than a speed of the distorted pulse and during the process, a post pulse following the main pulse is formed.

Meanwhile, as described above, the laser pulse passes through the amplification medium 132 several times so as to be amplified and during the process, some components of the post pulse can be transferred to the pre-pulse.

This is because the laser pulse to be amplified is stretched by using a wavelength as an axis. In a situation in which the main pulse and the post pulse exist together, if a frequency conversion of the laser pulse is performed, the laser pulse appears as a frequency-comb shape (ripple shape). Since the pulse is stretched due to a path difference according to a wavelength in the CPA method, the ripple exists in time, and the ripple influences the main pulse and the post pulse due to a nonlinear effect caused by the intensity of the beam, and thereby, a pre-pulse is formed at positions temporally symmetrical on the basis of the main pulse.

This will be described with reference to a graph below.

FIG. 4 is a graph illustrating a time-dependent intensity shape of a laser pulse in a temporally stretched manner before being incident on an initial amplification medium.

As illustrated in FIG. 4, the initially incident laser pulse has a shape in which density is concentrated at a central portion. At this time, the portion in which the initially incident laser pulse is concentrated at the central portion is referred to as a main pulse.

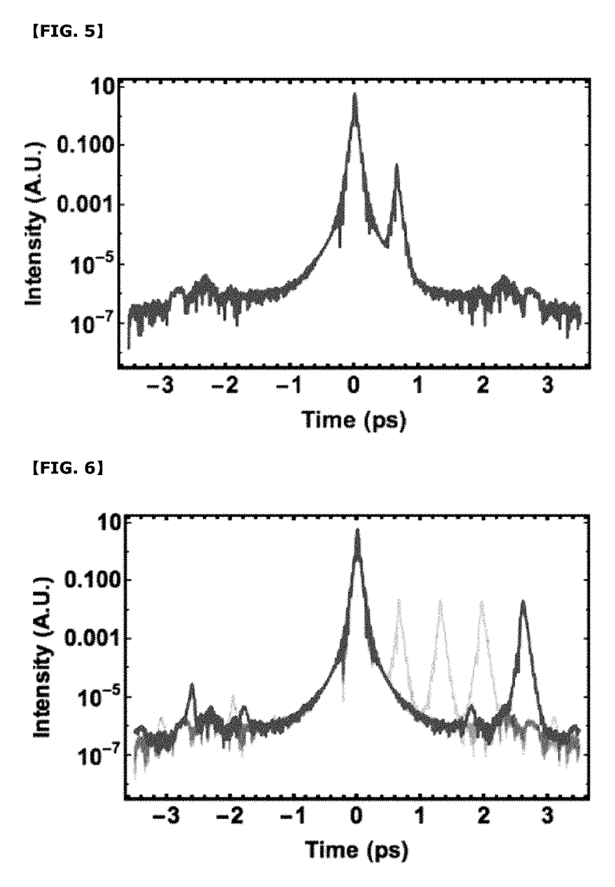

FIG. 5 is a graph illustrating a shape of the laser pulse after passing through the amplification medium once.

As illustrated in FIG. 5, it can be seen that, if the laser pulse passes through the amplification medium once, a post pulse following the main pulse is generated.

FIG. 6 is a graph illustrating a shape of the laser pulse after passing through the amplification medium several times. In the present embodiment, a shape of the laser pulse passing through the amplification medium four times is illustrated.

As illustrated in FIG. 6, as the number of times that the laser pulse passes through the amplification medium increases, the post-pulse increases and delays to be longer than the main pulse. In addition, it can be seen that the pre-pulse is formed at a position symmetrical to the post pulse with respect to the main pulse.

Among the pre-pulse and the post-pulse, particularly the pre-pulse arrives at a target ahead of the main pulse to act on the target in use of the laser pulse of ultra-high power, thereby, having a great influence on the experiment. That is, the pre-pulse first reacts with the target to change the property of the target, thereby, hindering the reaction made by the main pulse of the target, and energy can be reflected in some regions.

In addition, the post pulse may also act late to the target reacted by the main pulse and influences the target to hinder an accurate evaluation of the effect of the main pulse.

Accordingly, the present embodiment includes a laser pulse filter 140 capable of filtering the pre-pulse and the post pulse

That is, the laser pulse filter 140 filters the pre-pulse and the post-pulses, and makes only the main pulse pass through, and thereby, only the main pulse can reach the target.

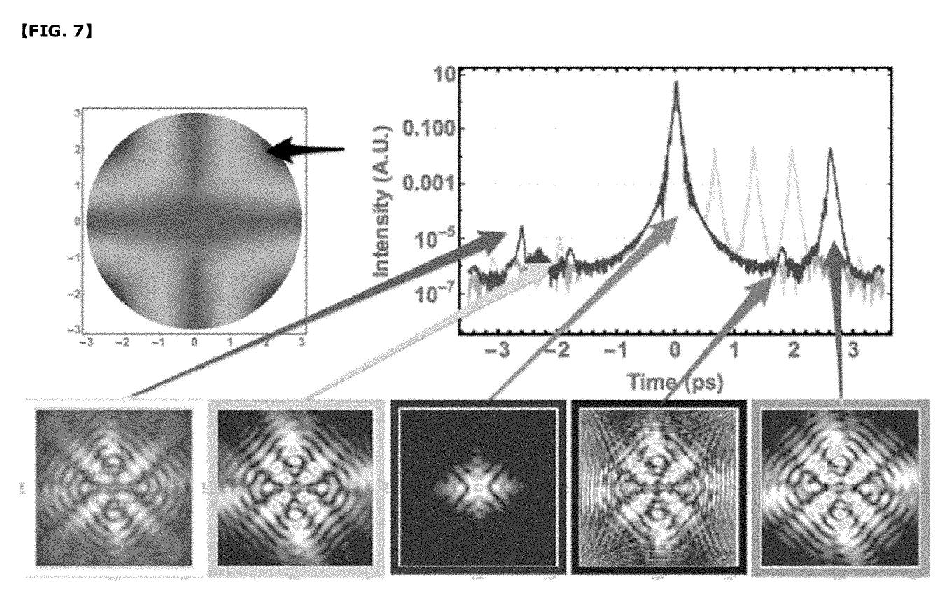

FIG. 7 is a graph illustrating a time (phase)-dependent cross-sectional shape of a laser pulse.

In the graph, when time is 0 ps, the main pulse is generated, the pre-pulse is generated before the main pulse, and the post-pulse is generated after the main pulse.

As illustrated in FIG. 7, the main pulse is concentrated at a central portion, and the pre-pulse and the post-pulse are not concentrated and are distributed to a peripheral portion in a spread shape.

More accurately, the pre-pulse and the post-pulse may have a shape having a hollow at the central portion.

Accordingly, the laser pulse filter can be installed at a place where the laser pulse temporally stretched by the pulse expander 120 is amplified by the amplification device and then focused.

For example, as illustrated in FIGS. 3 and 8, a laser pulse temporally stretched by the pulse expander 120 is amplified by the amplification device and then directed to the pulse compressor, and at this time, if the pulse compressor 150 is irradiated with a laser pulse of too strong intensity, the pulse compressor may be damaged, and thus, a diameter of the laser pulse amplified by the amplification device 130 can be enlarged to reduce a density thereof. A device for expanding the diameter of the laser pulse as described above is called a beam expander 134, and the beam expander 134 is provided between the amplification device 130 and the pulse compressor 150 and can include an optical system such as at least a pair of lenses.

As illustrated in FIG. 11, the laser pulse is focused and then expanded while passing through the beam expander 134, and the laser pulse filter can be installed at a point where the laser pulse is focused by the beam expander.

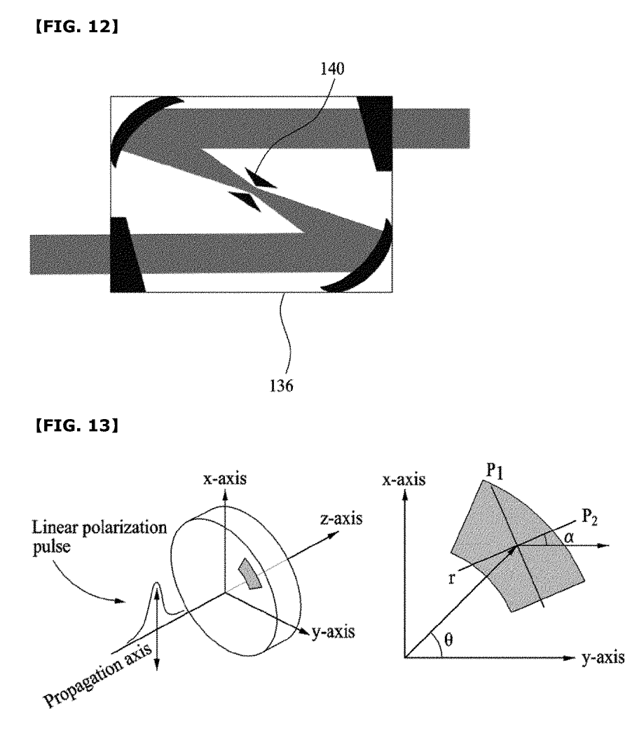

Of course, the present invention is not limited to that the laser pulse filter 140 is installed in the beam expander, and as illustrated in FIG. 12, the laser pulse filter can be installed anywhere as long as a beam is focused, such as being installed inside a reflective beam expander 136 for controlling a shape of the beam. The reflective beam expander 136 can be realized as a wedge chamber or the like.

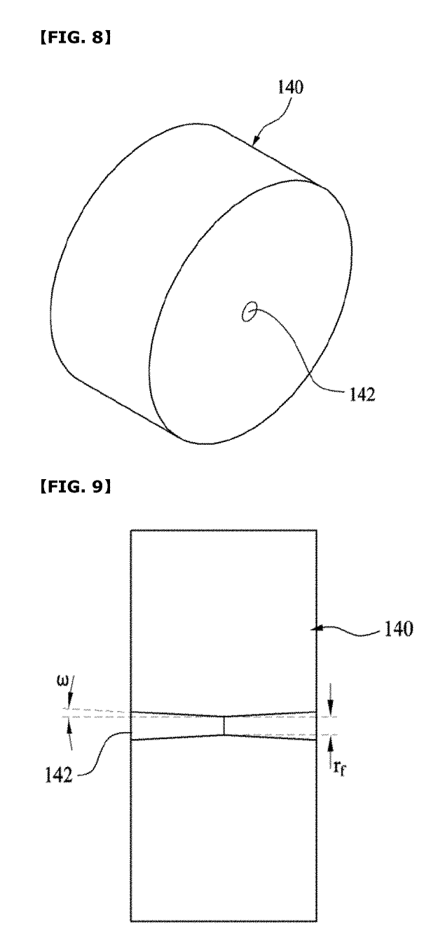

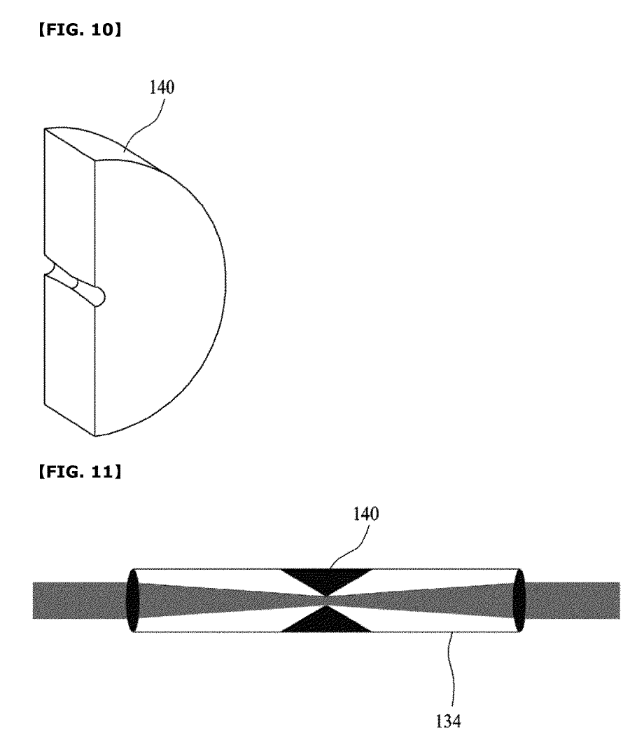

Meanwhile, a shape of the laser pulse filter 140 described above may have a filtering hole 142 through which a main pulse of a focused beam passes at a central portion, as illustrated in FIGS. 8 to 10.

The filtering hole is concentric with the pulse of the laser beam, is larger than a diameter of the main pulse, is smaller than diameters of the hollows at the central portions of the pre-pulse and the post-pulse, and can be formed to make the main pulse pass through and filter the pre-pulse and the post-pulse.

In addition, the filtering hole 142 can have a shape which is conically converged or divergent in consideration of a focusing angle of the beam to be focused and an angle of diffusing the focused beam.

That is, the filtering hole 142 can be formed in a shape in which a radius of a central portion of a cross section of the laser pulse filter is the smallest, and the radius increases toward an entrance and an exit of the laser pulse.

At this time, the radius of the central portion of the filtering hole 142 can have a length between the radius of the main pulse of the focused beam and radiuses of empty spaces of the central portions of the pre-pulse and the post-pulse.

In addition, the laser pulse filter 140 can be formed of a material capable of withstanding the laser pulse of high power.

In the present embodiment, an example will be described in which Ti:Sapphire having a diameter of 7 cm and a thickness of 2 cm is used as an amplification medium, and a diameter of the central portion of the filtering hole is 0.3 mm and a material thereof is Alloy 22 under the condition that a pumping laser is 100 J-10 Hz.

However, the diameter of the central portion of the filtering hole 142 can change depending on an output of the laser pulse, various other conditions, and the like, and hereinafter, a method of calculating the diameter of the main pulse of the focused laser pulse and the diameters of the central portions of the pre-pulse and the post-pulse.

In order to obtain the diameter of the focused laser pulse, it is necessary to calculate first a cross-sectional shape of the focused laser pulse.

First, a shape of an ideal beam can be represented by following Equation 1.

B{circ(r)}=2π∫∫₀^{r}^{₀}circ(r)J₀(2πrρ)rdr=J₁(2πρ)/ρ (Equation 1)

At this time, B{ }: Fourier-Bessel transform, Jₙ: n^{th} kind Bessel function, and circ(r₀): circle with radius in r₀.

In addition, r₀ is a diameter of the laser pulse beam before being focused, and ρ is a radius of the focused beam.

In a case of an ideal circular beam with no distortion at all, it can be represented as a circular function circ(r).

However, since it is impossible to avoid distortion in actual operation, it is necessary to calculate the shape of the beam including the distortion, and in this case, if circ(r)exp(iϕ(r,θ)) distortion is included, a focusing shape of the beam can be represented by Equation 2.

B{circ(r)e^{iϕ(r,θ)}}=2π∫∫circ(r)e^{iϕ(r,θ)}rdrdθ (Equation 2)

Meanwhile, a general shape of a cross-sectional intensity distribution of the circular beam can be the shape illustrated in FIG. 13. A left side of FIG. 13 shows a diagram illustrating a cross section in a coordinate system of a circular beam, and a right stage shows an enlarged diagram of a minute unit of the circular beam on the left side.

At this time, a radius of the focused laser pulse beam has to be obtained to determine a diameter of the filtering hole of the laser pulse filter, and since the main pulse has a centralized shape and the pre-pulse and the post-pulse are not concentrated and have a shape distributed and spread to the peripheral portion as illustrated in FIG. 7, the radius of the central portion where the laser pulse beam is focused has to be calculated for the main pulse, and a radius of the hollow in the central portion of the laser pulse beam has to be calculated for the pre-pulse and the post-pulse.

In the present embodiment, the radius of the main pulse having the centralized shape is defined as a distance from the central portion representing a maximum intensity to a point representing 10⁻⁵ of the maximum intensity.

In addition, since the central portion is empty and the pulse is distributed and spreads to the peripheral portion, the intensity of the central portion is the weakest, and for the pre-pulse and the post-pulse having a shape in which the intensity is stronger as the radius increases toward the peripheral portion, a distance from the central portion representing a minimum intensity to the point representing 10⁻⁵ of the maximum intensity is defined as a radius of the hollow.

In order to derive a cross-sectional shape of the laser pulse beam with the above-described criterion, it is necessary to know a spatial distribution (circ(r)) and a phase distortion (φ(r,θ)) of a beam energy.

At this time, the shape of the beam, that is, the spatial distribution can be assumed as a flat-top under the condition of using Ti:Sapphire having a diameter of 7 cm and a thickness of 2 cm as an amplification medium.

However, in order to obtain the phase distortion φ(r,θ)), it is necessary to accurately know a phase delay at each position of the laser pulse beam. The phase delay can be obtained from the following equation.

$$retardation \text{:} ∅ ( r , θ ) = Arg [ {E}_{x} ]$$

$$\vec{E} = ( \begin{matrix}Ex \\ Ey\end{matrix} ) , \\ \frac{d \vec{E}}{dz} = \frac{1}{2} ( \begin{matrix}{g}_{X} + i Δ {k}_{c} + i Δ {k}_{t} cos 2 α & - i Δ {k}_{t} sin 2 α \\ - i Δ {k}_{t} sin 2 α & {g}_{y} - t Δ {k}_{c} - t Δ {k}_{t} cos 2 α\end{matrix} ) \vec{E} ,$$

The above differentiation equation and a second matrix for representing the differentiation equation are methods independently designed by the present applicant.

At this time, gₓ and g_{y} are amplification rates of electric field components in the x and y polarization direction.

In addition,

$$Δ {k}_{c} = \frac{2 π}{λ} ( {n}_{x} - {n}_{y} )$$

and this equation means a phase delay due to intrinsic birefringence of a medium. Here, nₓ and n_{y} denote refractive indexes when the polarizations are x and y directions, respectively.

In addition,

$$Δ {k}_{t} = \frac{2 π}{λ} ( {n}_{p 1} - {n}_{p 2} )$$

and this equation means a phase delay due to birefringence generated by a thermal stress, nₚ₁ and nₚ₂ denote refractive indexes in the p1 and p2 directions, and p1 and p2 denote main axis directions of the thermal stress.

Meanwhile, nₚ₁−nₚ₂=½n₀³(ΔBₚ₁−ΔBₚ₁) and this equation means a difference in refractive index formed by the thermal stress, and n₀ denotes a normal refractive index of a medium.

In addition,

$$α = \frac{1}{2} {tan}^{- 1} ( \frac{2 Δ {B}_{xy}}{Δ {B}_{yy} - Δ {B}_{xx}} )$$

means an angular difference between the main axis direction of the thermal stress and x-y orthogonal coordinates.

At this time, AB denotes the amount of change of relative dielectric permittivity and has the following relationship with the refractive index.

$$\frac{{x}_{1}^{2}}{{n}_{1}^{2}} + \frac{{x}_{2}^{2}}{{n}_{2}^{2}} + \frac{{x}_{2}^{2}}{{n}_{2}^{2}} = {B}_{1} {x}_{1}^{2} + {B}_{2} {x}_{2}^{2} + {B}_{3} {x}_{3}^{2} = 1$$

Accordingly, a change of the refractive index can be obtained from AB.

Meanwhile, a process of deriving the relative dielectric permittivity is as follows.

$$( \begin{matrix}Δ {B}_{zz} \\ Δ {B}_{xx} \\ Δ {B}_{yy} \\ Δ {B}_{xy} \\ Δ {B}_{yz} \\ Δ {B}_{zx}\end{matrix} ) = {P}_{mn} {s}_{rn} {σ}_{rn} = {π}_{mn} ( \begin{matrix}{σ}_{zz} \\ {σ}_{xx} \\ {σ}_{yy} \\ {σ}_{xy} \\ {σ}_{yz} \\ {σ}_{zx}\end{matrix} )$$

Here, pₘₙ is an elasto-optics coefficient, sᵣₙ is an elasto-compliance coefficient, and σᵣₙ is a thermal stress generated inside the medium.

At this time, p and s tensors are characteristics of the medium and physical quantities are given thereto.

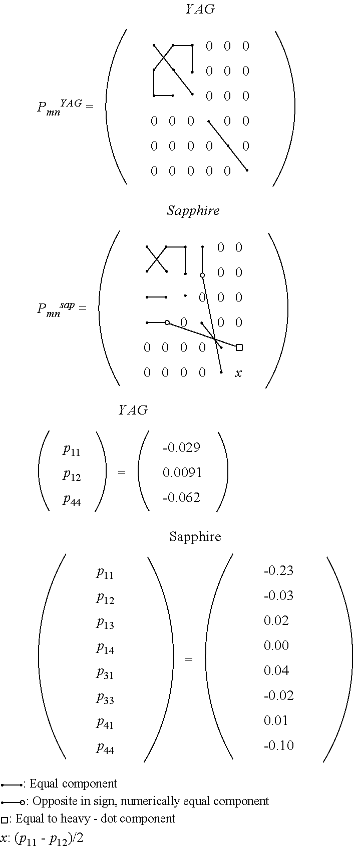

Meanwhile, the thermal stress generated inside the medium can be represented by the following equations.

Q is the amount of heat generated per unit area.

σᵣ(r)=QS(r²−r₀²)

σ₃(r)=QS(3r²−r₀²)

σ₂(r)=QS(2r²−r₀²)

Q=Pₕₑₐₜ/πr₀²L

S=αE/16κ(1−ν)

Here r₀ is a radius of a circular sapphire which is an amplification medium, and r is a location (radius) of a related point.

In addition, Pₕₑₐₜ is heat generated in the amplification medium during oscillation of laser and L is a thickness of the amplification medium.

In addition, in the above equations, α is a thermal expansion coefficient, and E is an elastic modulus of the amplification medium. In addition, kappa (κ) is a thermal conductivity of the amplification medium, and nou (ν) is a Poissons ratio of the amplification medium.

If the coefficients in the above polar coordinate equation are converted into orthogonal coordinates, following equations can be established.

σₓₓ(r,θ)=σᵣ(r)cos²(θ)+σ_{θ}(r)sin² θ

σ_{yy}(r,θ)=σᵣ(r)sin²(θ)+σ_{θ}(r)cos² θ

σ_{xy}(r,θ)={σᵣ(r)−σ_{θ}(r)}cos(θ)sin(θ)

Accordingly, the radiuses of the pre-pulse and the post-pulse of the main pulse of the focused laser pulse beam can be obtained through the above-described processes, and thereby, the diameter of the filtering hole can be determined.

Meanwhile, the filtering holes are formed in a conical shape, and at this time, an angle (ω) of an inner circumferential surface of the filtering hole can be represented by the following equation.

$$ω = {tan}^{- 1} ( \frac{( {r}_{b} - {r}_{f} )}{f} )$$

Here, f is a focal length due to an optical component for focusing the laser beam pulse, r_{b} is a radius of the laser pulse beam before being focused, and r_{f} is a radius of the central portion of the filtering hole 142.

As described above, the preferred embodiments of the present invention are described. It will be apparent to those skilled in the art that the present invention can be embodied in other specific forms without departing from the spirit or scope of the invention in addition to the embodiments described above. Therefore, the above-described embodiments have to be considered as illustrative rather than restrictive, and the present invention is not limited to the above description and can be modified within the scope of the appended claims and equivalents thereof.

1. A laser output device including a laser pulse filter comprising:
a laser oscillator that oscillates a source laser pulse;
a pulse expander that temporally stretches the source laser pulse which is oscillated by the laser oscillator;
an amplifier that amplifies the laser pulse which is temporally stretched by the pulse expander;
a laser pulse filter that filters a pre-pulse and a post-pulse which are included in the amplified laser pulse; and
a pulse compressor that temporally compresses the laser pulse passing through the laser pulse filter.

2. The laser output device including a laser pulse filter of claim 1, wherein the laser pulse filter is installed at a point where the amplified laser is focused.

3. The laser output device including a laser pulse filter of claim 2, wherein the laser pulse filter is installed between the amplifier and the compressor.

4. The laser output device including a laser pulse filter of claim 3, further comprising:
a beam expander that expands a diameter of a beam of the amplified laser pulse,
wherein the laser pulse filter is installed in a location where the beam is focused in the beam expander.

5. The laser output device including a laser pulse filter of claim 2,
wherein the laser pulse filter has a filtering hole which filters a post-pulse and a pre-pulse of a focused beam and through which a main pulse passes.

6. The laser output device including a laser pulse filter of claim 5,
wherein the filtering hole has a shape in which a radius of a central portion is the smallest and the radius increases toward an entrance and an exit of the laser pulse.

7. The laser output device including a laser pulse filter of claim 6,
wherein the radius of the central portion of the filtering hole has a length between a radius of the main pulse of the focused beam and radiuses of hollows of central portions of the pre-pulse and the post pulse.

8. The laser output device including a laser pulse filter of claim 6,
wherein a radius of the main pulse is a distance from a point where a maximum intensity of the main pulse appears to a point where an intensity reaches 10⁻⁵ of the maximum intensity, in a shape of the focused beam.

9. The laser output device including a laser pulse filter of claim 6,
wherein radiuses of hollows of the central portions of the pre-pulse and the post-pulse are a distance from a point where beam intensities of the central portions of the pre-pulse and the post-pulse are the smallest in a shape of a focused beam to a point where an intensity becomes 10⁻⁵ of a maximum intensity of the pre-pulse and the post-pulse.

10. The laser output device including a laser pulse filter of claim 8,
wherein the shape of the focused beam is obtained by an equation of B{circ(r)e^{iϕ(r,θ)})}=2π∫∫circ(r)e^{iϕ(r,θ)}rdrdθ. (At this time, circ(r) means a spatial distribution of beam energy, and φ(r,θ) means distortion of a phase)

11. A laser pulse filter, which filters a pre-pulse and a post-pulse among laser pulses of a laser output device which uses a chirped pulse amplification (CPA) method,
wherein the laser pulse filter has a filtering hole that is formed to filter the pre-pulse and the post-pulse which are included in an amplified laser pulse.

12. The laser pulse filter of claim 11,
wherein the filtering hole has a smallest radius of a central portion and a radius which increases toward an entrance and an exit of a beam.

13. The laser pulse filter of claim 12,
wherein the radius of the central portion of the filtering hole has a length between a radius of a main pulse of a focused beam and radiuses of hollows of central portions of the pre-pulse and the post pulse j.

14. The laser pulse filter of claim 13,
wherein the radius of the main pulse is a distance from a point where a maximum intensity of the main pulse appears to a point where an intensity reaches 10⁻⁵ of the maximum intensity, in a shape of the focused beam.

15. The laser pulse filter of claim 13,
wherein radiuses of hollows of the central portions of the pre-pulse and the post-pulse are a distance from a point where beam intensities of the central portions of the pre-pulse and the post-pulse are the smallest in a shape of a focused beam to a point where an intensity becomes 10⁻⁵ of a maximum intensity of the pre-pulse and the post-pulse.

16. The laser pulse filter of claim 14,
wherein the shape of the focused beam is obtained by an equation of B{circ(r)e^{iϕ(r,θ)})}=2π∫∫circ(r)e^{iϕ(r,θ)}rdrdθ. (At this time, circ(r) means a spatial distribution of beam energy, and φ(r,θ) means distortion of a phase)

17. The laser output device including a laser pulse filter of claim 9,
wherein the shape of the focused beam is obtained by an equation of B{circ(r)e^{iϕ(r,θ)})}=2π∫∫circ(r)e^{iϕ(r,θ)}rdrdθ. (At this time, circ(r) means a spatial distribution of beam energy, and φ(r,θ) means distortion of a phase)

18. The laser pulse filter of claim 15,
wherein the shape of the focused beam is obtained by an equation of B{circ(r)e^{iϕ(r,θ)})}=2π∫∫circ(r)e^{iϕ(r,θ)}rdrdθ. (At this time, circ(r) means a spatial distribution of beam energy, and φ(r,θ) means distortion of a phase)
